(19) United States
(12) Patent Application Publication
(10) Pub. No.: US 2007/0181615 A1
(43) Pub. Date: Aug. 9, 2007

(54) Drip resistant dispensing valve for fluids

(75) Inventors: Gary R. Allanson, Crownsville, MD (US); Mitchell A. Friedman, Randallstown, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: International Dispensing Corporation, Millersville, MD (US)

(21) Appl. No.: 11/703,939

(22) Filed: Feb. 8, 2007

Related U.S. Application Data
(60) Provisional application No. 60/771,321, filed on Feb. 8, 2006.

(51) Int. Cl. B67D 3/00; F16K 31/00

(52) U.S. Cl. 222/518; 222/509; 251/339

(57) ABSTRACT

A drip resistant dispensing valve for fluids is disclosed, which provides a dispensing outlet configured to minimize the tendency for fluid to drip from the valve following a dispensing operation. The dispensing outlet exhibits curved interior surfaces and a curved outlet face construction; the face situated a distance away from the valve body. Such construction assists in minimizing the retention of fluid on the surfaces of the dispensing outlet, and migration of the fluid to surfaces outside of the dispensing outlet that could tend to promote growth of biological contaminates and/or provide additional surfaces that could pool fluid following a dispensing operation and thereafter drip from the valve. A shell is provided around the dispensing outlet to assist in avoiding contamination of the valve and of the fluid being dispensed through the valve, and to aid in positioning a receptacle for receiving fluid from the dispensing valve.

### CROSS REFERENCE TO RELATED APPLICATION

This application is based upon and claims benefit of copending and co-owned U.S. Provisional Patent Application Ser. No. 60/771,321 entitled “Drip Resistant Dispensing Valve for Fluids”, filed with the U.S. Patent and Trademark Office on Feb. 8, 2006, the specification of which is incorporated herein by reference.

### BACKGROUND OF THE INVENTION

1. Field of the Invention

The present invention relates to fluid dispensing apparatus and, more particularly, to a robust, relatively simple, low-cost, and easily actuatable dispensing valve for dispensing fluid from a source of such fluid, which valve is configured so as to reduce the tendency for residual fluid to collect on and ultimately drip from the valve following a dispensing operation, and to minimize the risk of contamination of the valve and the fluid that is to be dispensed.

2. Description of the Background

Dispensing valves for dispensing fluid from fluid containers, systems, or other sources of such fluid are shown by U.S. Pat. Nos. 3,187,965; 3,263,875; 3,493,146; 3,620,425; 4,440,316; 4,687,123; 5,918,779; 6,491,189; and 6,742,680. Such valves can be used, for example, in a system for dispensing beverages or other liquids used by consumers in the home. Low cost, trouble-free, and reliable valve action are significant considerations in these applications. Low cost is particularly important if the valve is to be sold as a disposable item as, for example, where the valve is provided attached to a filled fluid container and discarded along with the container when the fluid has been consumed.

Unfortunately, many of the dispensing valve mechanisms available fail to provide a dispensing outlet that does not avoid the collection of liquid on its surfaces, thereby resulting in the unwanted release of liquid from the dispensing outlet after it has been shut off. For instance, during a dispensing operation, fluid from a storage container typically contacts the inside surfaces of a dispensing outlet on a dispensing valve. These inner surfaces can tend to collect liquid during use of the dispensing valve, such that after fluid is dispensed and the user has removed the cup, glass, or other receptacle for receiving the liquid and released the actuation mechanism of the dispensing valve, the collected liquid on the inner surface remains. Thus, not all of the liquid is caught in the receptacle; rather, some accumulates on such inner surfaces and may drip off such surfaces after the dispensing operation.

Still further, many of the currently employed dispensing valves promote the development of unsanitary conditions in and around the dispensing outlet. This may be due to the configuration of the dispensing outlet, which allows direct contact between the outlet and the user or the receptacle employed by the user. Through such direct contact with the dispensing outlet, various bacteria, pathogens, and the like may be transmitted to the surfaces of the dispensing outlet. Many such pathogens and the like may not be readily ascertainable through visual inspection and may survive cleaning of the dispensing outlet. This may lead to such unwanted organisms traveling further into the dispensing valve, and likewise into a container to which the dispensing valve is attached and contaminating the liquid within.

In U.S. Pat. No. 3,187,965 to Bourget, a dispensing valve for a milk container is shown having a generally integral valve body connected at one end to the milk container. The valve body has an L-shaped passage formed therein defining an inlet opening at one end in communication with the milk container and a discharge outlet at the opposite end for discharging the milk to the exterior of the container when the valve is opened using a push-button actuator. The discharge outlet is fully exposed to the outside environment, thus promoting contact with potentially contaminated surfaces, and no provision is made to prevent residual undispensed fluid from collecting in and/or dripping from the discharge outlet.

Another valve, shown in U.S. Pat. No. 3,263,875 to Lofdahl, has a similarly configured dispensing outlet and a push-button actuator, and once again lacks any provision to prevent residual undispensed fluid from collecting in and/or dripping from the discharge outlet, and fully exposes the discharge outlet to the outside environment, thus promoting contact with potentially contaminated surfaces.

Likewise, commercial attempts have been made to provide low-cost dispensing valves for use with disposable containers, but such efforts have met with limited success. For example, Waddington & Duval Ltd. provide a press tap for use with disposable containers (such as wine boxes, water bottles, and liquid laundry detergent containers) under model designations COM 4452 and COM 4458, both of which provide a depressible button actuator operatively connected to a valve closure for moving the valve closure away from a valve seat to dispense fluid through a discharge outlet. As with the examples provided above, the discharge outlet is fully exposed to the outside environment, thus promoting contact with potentially contaminated surfaces, and no provision is made to prevent residual undispensed fluid from collecting in and/or dripping from the discharge outlet.

Similarly, the Jefferson Smurfit Group provides a similar tap for use with disposable containers under the model designation VITOP. Once again, the Jefferson Smurfit Group tap construction is configured such that the discharge outlet is fully exposed to the outside environment, thus promoting contact with potentially contaminated surfaces, and no provision is made to prevent residual undispensed fluid from collecting in and/or dripping from the discharge outlet.

Moreover, such valve constructions are configured such that undispensed fluid will remain in the valve behind the valve seat after use in a significant portion of the valve body and away from the container to which such valve is attached (and likewise away from any refrigerated environment in which such container is stored). This increases the risk of spoilage of such volume of fluid resting within the valve body after each use. Still further, such valve constructions lack the physical integrity to withstand vigorous sterilization procedures required of many fluid dispensing applications, including irradiation at exposures of up to as high as 5.0 MRAD and high temperature steam and chemical sterilization procedures.

Thus, although substantial effort has been devoted in the art towards development of low-cost valves of this general type, there remains an unmet need for a disposable valve having a discharge outlet that reduces the tendency for residual fluid to collect in and drip from the dispensing outlet while maintaining a simple construction for ease of manufacture, and that exhibits a configuration that tends to prevent, or at least minimize the risk of, contact between potentially contaminating external surfaces with the surfaces of the discharge outlet. Likewise, there remains an unmet need for a dripless valve that is easier to use than prior known valves and that does not require that the user exert large forces to hold the valve open. This problem is complicated by the fact that the tendency of a spring or other resilient member to maintain the valve in a closed position should provide the force necessary to assure leak-free seating of the valve seal when in such closed position. Likewise, there remains an unmet need for a disposable valve that is sufficiently robust so as to be able to withstand vigorous sterilization procedures, that reduces heat transfer through the valve between the interior and exterior of the fluid container, and that does not trap a significant amount of fluid outside of the intended storage vessel between dispensing cycles.

There is further need for a valve that can be adapted, during manufacture, to provide the desired liquid flow rate for a particular set of conditions, such as liquids of differing viscosity and the liquid pressure or “head” available to force the liquid through the valve body. A valve that discharges a thick, high-viscosity fluid such as cold maple syrup or orange juice concentrate at a desirable rate will discharge a low-viscosity fluid such as water or wine under the same pressure at a far higher rate. Therefore, it would be desirable to provide a valve that can be fabricated readily using normal production techniques such as injection molding in a range of configurations, having different resistance to fluid flow, to provide for these different conditions. It would be particularly desirable to provide a valve that can be fabricated in these different configurations with only minor modifications to the molds and other tools used to make the valve.

### SUMMARY OF THE INVENTION

It is, therefore, an object of the present invention to provide a fluid dispensing valve that avoids the disadvantages of the prior art.

Accordingly, the present invention provides a drip resistant dispensing valve including a discharge mechanism having decreased liquid retention properties. Further, the discharge mechanism of the drip resistant dispensing valve provides an outer shell that promotes the avoidance of direct contact between a user and/or receptacle and the dispensing outlet.

It is another object of the present invention to provide a fluid dispensing valve that is drip resistant and avoids the unwanted accumulation of liquids outside of the liquid container to which the valve is attached.

It is a further object of the present invention to provide a fluid dispensing valve that promotes the avoidance of contaminants contacting and/or inhabiting the dispensing outlet, other interior surfaces of the dispensing valve, and/or the liquid container.

Disclosed herein is a drip resistant dispensing valve for fluids that provides for ease of use by requiring only a minimal force exerted on the valve actuator to maintain the valve in an open position, and that offers a simple, ergonomic design and robust functionality capable of dispensing a wide variety of products.

With regard to a first aspect of a particularly preferred embodiment, a valve includes a discharge mechanism having properties that reduce or eliminate the propensity for residual fluid to remain on such discharge mechanism following a discharge or dispensing operation. The discharge mechanism provides an outer shell that promotes the avoidance of direct contact between a user, a receptacle, and/or other potentially contaminating surfaces and the dispensing outlet of the discharge mechanism.

With regard to another aspect of a particularly preferred embodiment, the valve body and actuator are formed of a polypropylene copolymer with an average wall thickness of approximately 0.06 inches, and the valve seal is formed of a thermoplastic rubber having an average thickness of about 0.03 inches. Such dimensional characteristics and materials allow the drip resistant dispensing valve to withstand the highest aseptic sterilization regimen as outlined by the Food & Drug Administration (FDA) and maintain the sterility of a product as specified by the National Sanitation Foundation (NSF) guidelines. More specifically, the dispensing apparatus is able to withstand either gamma or cobalt irradiation at the maximum dose of 5.0 MRAD (50 Kilogray) in the sterilization process. The dispensing apparatus is able to withstand the high temperatures associated with the steam and chemical sterilization processes required in the filling process. The dispensing apparatus is capable of withstanding these combined sterilization regimens without degrading the valve structure or operation. Thus, the valve of the instant invention may be used to dispense products ranging from aseptic products such as dairy, 100% juice and soy products, to commercially sterile products such as preserved juice and coffee products, to non-sterile fluids such as chemical solvents.

In order to allow a minimal force for holding the valve in an open position, a resilient valve actuator having the characteristics of a nonlinear spring is provided at an actuator end of the valve body and operatively connected to a plunger, with the opposite end of the plunger having mounted thereon a resilient valve seal. An intermediate discharge outlet is positioned between the actuator end and the valve seal, such discharge outlet being placed in fluid communication with the interior of a fluid container to which the valve is attached when the valve is in an open position. A valve port wall is positioned between the valve seal and the dispensing chamber providing a plurality of ports for controlling the flow of fluid through the valve body when the valve is in an open position. The valve and the valve port wall are positioned such that when the valve is installed on a liquid container, virtually no liquid will be trapped by the valve structure outside of the insulated container, thus preventing the spoilage of a dose of liquid resting in the valve after each dispensing cycle. A push-button is provided for actuating the drip resistant dispensing valve and is exposed to the exterior of a fluid container to which the drip resistant dispensing valve is attached. In one embodiment of the instant invention, the push-button is concentrically mounted within a breakaway circular rim. Upon first using the drip resistant dispensing valve, a user depresses the push-button, dislodging the circular rim from the button, and thereby providing evidence that the valve had been opened, thus providing a tamper-evident actuator. The valve may be manufactured with a variety of port configurations to provide for the dispensing of fluids of varying viscosities.

Such valve is also preferably configured so as to withstand sterilization procedures including irradiation up to 5.0 MRAD and high temperature steam and chemical sterilization processes without degradation of the integrity of the valve structure or operation, and thus may be used for dispensing a wide variety of products ranging from aseptic products (free from microorganisms) to non-sterile products.

The simplicity and functionality of the drip resistant dispensing valve of the instant invention enables its manufacture and automatic assembly with multiple cavity tools, which in turn reduce manufacturing costs, and offers the market a low cost dispensing solution. The simplicity and functionality of the design also enables the dispensing apparatus to be easily customized in the manufacturing process to fit a wide range of dispensing packages such as a flexible pouch, flexible bag, or semi-rigid plastic container. The drip resistant dispensing valve of the instant invention is also configured to adapt easily to a wide range of filling machines and filling conditions worldwide.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is an illustration of a drip resistant dispensing valve in accordance with an exemplary embodiment of the present invention;

FIG. 2 is a top view illustrating the actuation end of the drip resistant dispensing valve shown in FIG. 1;

FIG. 3 is a perspective cut-away view illustrating a shell and discharge outlet of the drip resistant dispensing valve shown in FIG. 1;

FIG. 4 is an expanded partial cut-away view illustrating the drip resistant dispensing valve shown in FIG. 1;

FIG. 5 is a cross-section view illustrating the drip resistant dispensing valve shown in FIG. 1;

FIG. 6 is a side cross-sectional view of an actuator for use with the drip resistant dispensing valve shown in FIG. 1;

FIG. 7 is an elevational view of the valve seal shown in FIGS. 4-6;

FIG. 7a is a cross-section of the valve seal taken along line ‘A-A’ of FIG. 7;

FIG. 8a is a graph illustrating certain forces acting during the operation of the drip resistant dispensing valve in accordance with an exemplary embodiment of the present invention;

FIG. 8b is a graph illustrating certain forces acting during the operation of the drip resistant dispensing valve in accordance with another embodiment of the present invention; and

FIG. 9 is a view illustrating a valve body in accordance with a further embodiment of the invention.

### DETAILED DESCRIPTION OF PREFERRED EMBODIMENTS

The invention summarized above and defined by the enumerated claims may be understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

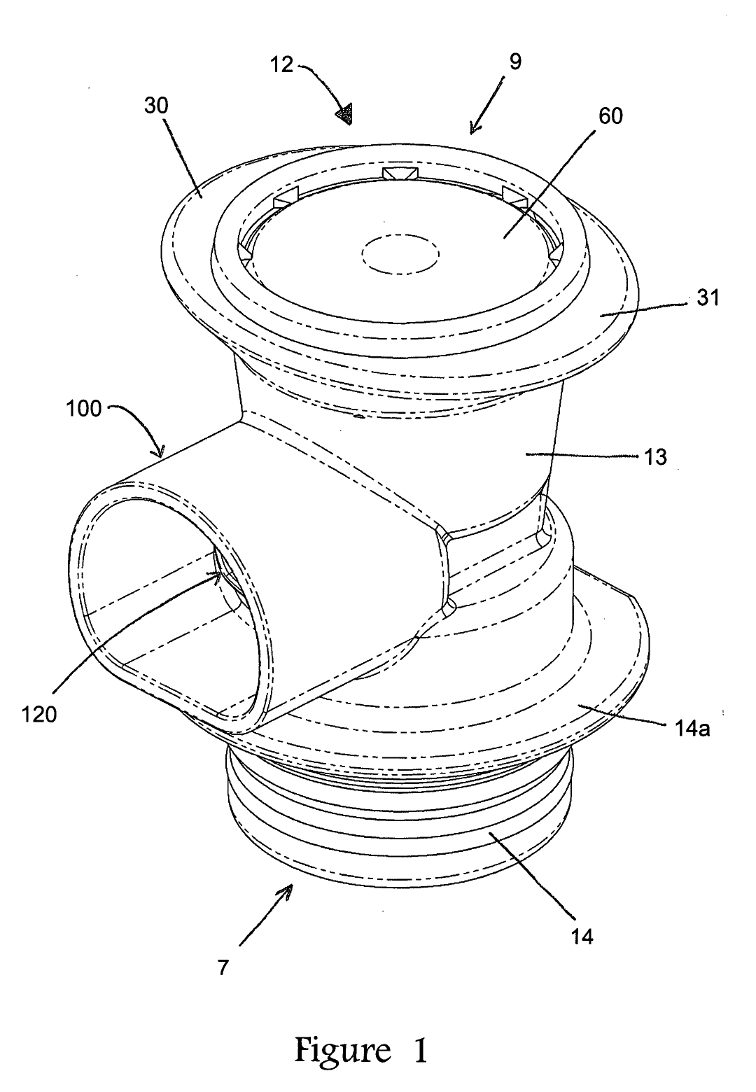

Referring to the drawings, FIG. 1 shows a drip resistant dispensing valve 12 in accordance with one embodiment of the present invention. As will be described in greater detail below, valve 12 is configured for attachment to a fluid container (not shown), which may be a rigid container (such as a thermos or plastic bottle), a flexible bag or pouch, or any other fluid container. The drip resistant dispensing valve 12 may be so situated on a fluid container so as to allow dispensing of fluid under gravity flow, or alternately, where the source of fluid is under a head of pressure, provided by a source other than gravity.

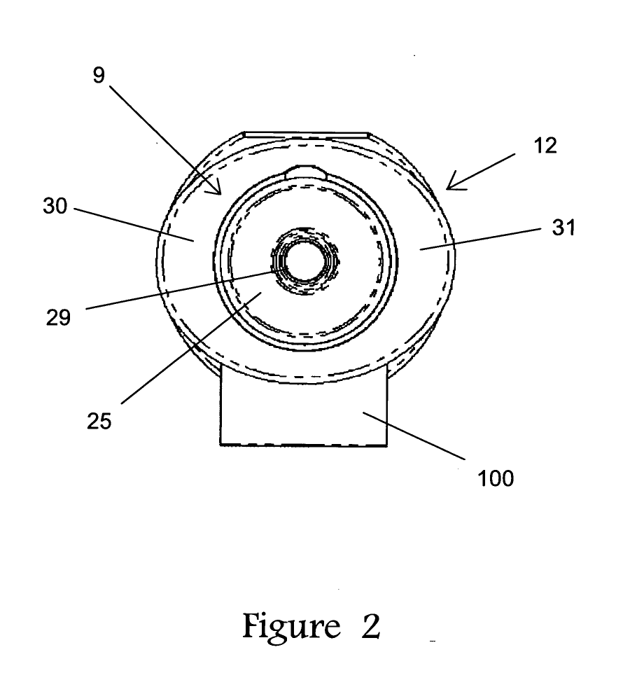

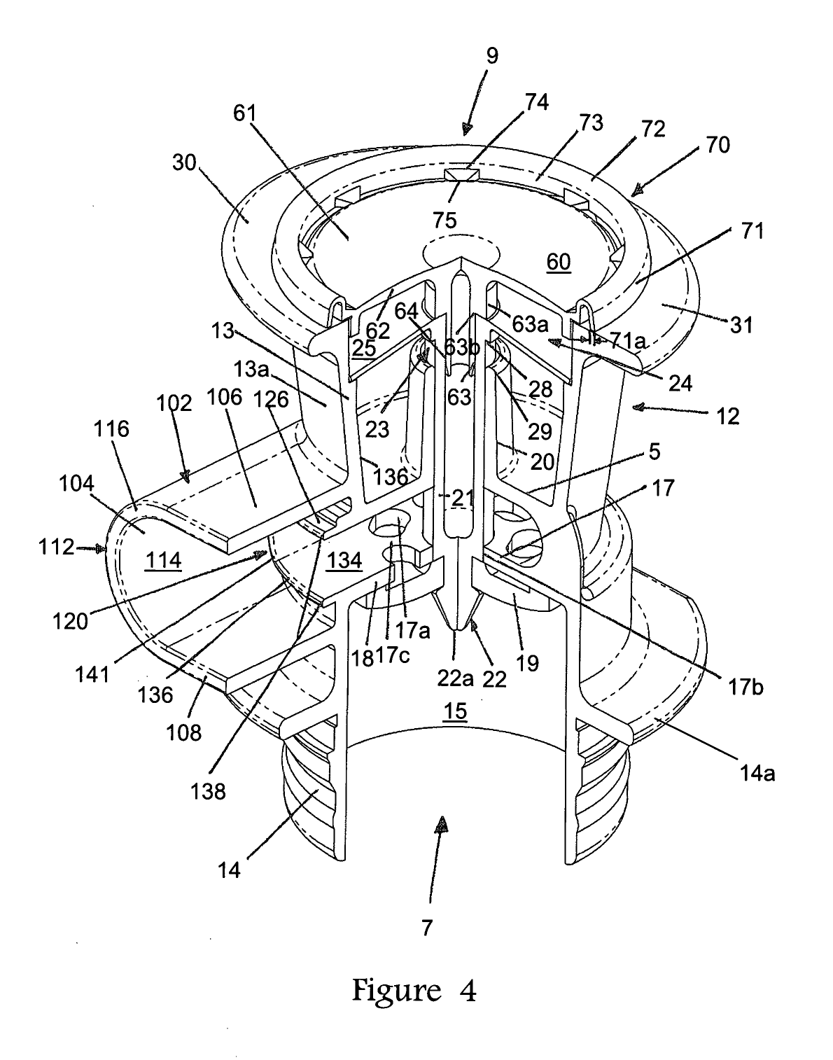

As is shown in FIGS. 1 to 7 of the drawings, drip resistant dispensing valve 12 has a generally tubular valve body 13 having an outer wall 13a and an inner wall 13b. The valve body has an inner or inlet end 7, and an opposite outer or actuation end 9, and an axial direction extending between these ends. Although the valve body 13 is shown generally in the form of a round cylindrical tube, the valve body may be round, square, octagonal or other shape adapted for the application to which the drip resistant dispensing valve 12 will be applied. Alternately, only a portion of the valve body 13 may have such alternate shape, with the remainder of the valve body maintaining a generally cylindrical shape. For instance, inlet end 7 may have an oblong configuration where it connects to a fluid container, while the remainder of the valve body may maintain a generally cylindrical configuration. Valve body 13 is provided with features 14 for connecting the valve body 13 to a fluid container or other source of fluid to be dispensed so as to bring the inlet opening 15 (FIG. 4) formed in the valve body 13 in communication with the fluid to be dispensed. The particular connecting features 14 depicted in the drawings include ribs encircling the exterior of the valve body near the inlet end 7. These ribs are arranged to form a fluid-tight, press-fit connection between the exterior of the valve body and the interior of an outlet provided in the container. Other suitable connecting and sealing features may be used in addition to or in lieu of ribs. For example, the valve body 13 can be provided with threads or bayonet-type locking features that can be mated with features of the container. In addition, auxiliary sealing elements such as resilient O-rings or other gaskets can be provided on the container or on the valve body for engagement between the valve body and the container.

In a preferred embodiment, a discharge mechanism for the drip resistant dispensing valve 12 includes a shell 100 at least partially encompassing a discharge outlet 120. In a preferred embodiment, the shell 100 and discharge outlet 120 are integrally connected with or formed in the valve body 13 at a position between the inlet end 7 and actuator end 9. It is to be understood that shell 100 may be connected with valve body 13 through the use of various connection mechanisms, such as a threaded connection, compression lock connection, snap fit connection, friction fit connection, and the like. The shell 100 and discharge outlet 120 are disposed outside of the container or other source of fluid when the valve body 13 is engaged with the container. The shell 100 and discharge outlet 120 are generally in the form of a short tubular member extending in the direction perpendicular to the axial direction of the valve body. Discharge outlet 120 provides communication between an outside environment and the interior of the valve body 13.

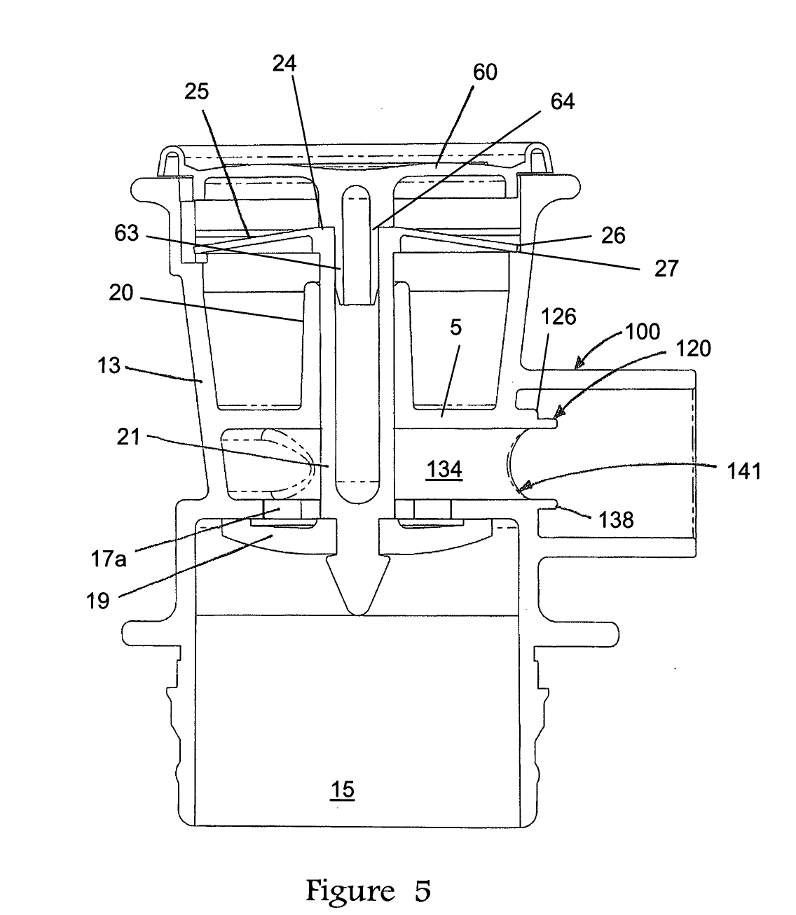

Discharge outlet 120 is configured so as to prohibit fluid being dispensed from outlet 120 from coming into contact with and/or collecting on the interior of shell 100. More particularly, discharge outlet 120 includes outer wall 126 that forms a projecting surface extending from outer wall 13a of valve body 13 so as to direct all flow through an outlet channel 134. Fluid flowing through the outlet channel 134 may run along the interior walls of discharge outlet 120, but when it reaches the outer edge of such discharge outlet 120, it has no path but to remain on the edge of the discharge outlet 120 or fall from the valve into the container into which the fluid is being dispensed. The outer wall 126 of discharge outlet 120 extends away from wall 13a, thus creating a distal separation between the open face of discharge outlet 120 and the interior, back wall of shell 100 (formed by the outer wall 13a of the body). As shown in FIGS. 4 and 5, outer wall 126 of discharge outlet 120 terminates in a curved front face 136 that, in effect, creates a projection 138 at the central portion of outer edge 136. To promote a dripless feature, projection 138 should be as thin as possible (consistent with good molding practices), and should extend outward from outer wall 13a of valve body 13 a distance that is at least three times the thickness of projection 138, and will preferably extend outward from outer wall 13a a distance greater than three times the thickness of projection 138. The distal separation between the end of such projection 138 and the outer wall 13a of the body prevents fluid being dispensed through discharge outlet 120 from contacting the inner surfaces of shell 100, as the fluid is unable, on its own, to traverse the 180 degree turn that would be necessary in order to migrate to those interior surfaces of shell 100. In this manner, residual undispensed fluid cannot pool on the inner surfaces of shell 100 and later drip off those surfaces at an undesirable time. Therefore, contamination of the interior of shell 100 (and establishment of sites on those surfaces at which biological contaminates might grow) is minimized, if not prevented altogether.

Thus, discharge outlet 120 is configured to substantially prevent fluid from collecting on the interior surfaces of the outlet and remaining there following a dispensing operation. More particularly, outer wall 126 extends outward from valve body 13 and terminates in outer edge 136 defining a generally oblong opening. The circumferential edge traversing outer edge 136 provides a substantially rounded/curved edge that traverses the top, bottom, and sides of projection 138. In a preferred embodiment, the outer edge 136 is shaped in a generally half-cylinder form. Alternately, the outer edge 136 may be shaped into a generally “rounded” form using variously angled sides.

Projection 138 preferably lies generally in a curved plane having a uniform radius of curvature about a central axis of valve body 13. Side portions 141 of projection 138 thus curve towards this central portion of outer edge 136, in turn directing any fluid that contacts the interior of discharge outlet 120 towards this single location, minimizing the tendency of any residual fluid to remain on the interior surfaces of discharge outlet 120. The interior of discharge outlet 120 defines the discharge outlet channel 134 that assumes a similar oblong shape with curved ends.

Shell 100 includes an outer wall 102 and inner wall 104 and has a shell top side 106, shell bottom side 108, shell right side 110, and shell left side 112. In the current embodiment, the shell top, right, and left sides 106, 110, 112 are integrally connected and configured in a generally cylindrical shape. The bottom side 108 is also integrally connected with the right and left sides 110, 112, but forms a generally planar surface. Alternative configurations for shell 100 may be employed, such as in the shape of a square, rectangle, other polygonal shapes, or as a cylinder, oval, oblong, and other shapes as contemplated by those of ordinary skill the art, without departing from the scope and spirit of the present invention.

An outer edge 116, which is formed at the opposite end of shell 100 from its connection with the outer wall 13a of the valve body 13, preferably provides a generally rounded/curved edge that traverses the top, bottom, right, and left sides between the outer wall 106 and inner wall 104.

Shell 100 further includes a shell channel 114 that provides an open passage through the interior of shell 100. The sides of the shell channel 114 are defined by the shell inner wall 104. In a preferred embodiment, the shell channel 114 defines the open passage through shell 100 that surrounds the discharge outlet 120. Shell channel 114, similar to shell 100, extends in a perpendicular direction from the axial direction of the valve body 13.

The length that the shell 100 extends from the outer wall 13a of valve body 13 may increase the ease with which a user may proximally locate a receptacle next to the shell 100 for receiving the liquid. Further, the size of shell channel 114 may promote the use of the drip resistant dispensing valve 12 with variously sized receptacles, such as cups, water bottles, and the like. For instance, the generally cylindrical shape of the shell 100 may allow for its insertion within the mouth of a water bottle. This may promote a decrease in the amount of “lost” liquid or spillage during operation of the drip resistant dispensing valve 12.

Further, shell 100 is configured to decrease the risk of contamination of the discharge outlet 120 and possibly a liquid within a container to which the drip resistant dispensing valve 12 may be attached. For instance, sufficient distance is provided between the outer edge 116 of shell 100 and the outer edge 136 of the discharge outlet 120 to reduce the risk of contaminates on the outer edge 116 of the shell 100 traveling or migrating to the outer edge 136 of discharge outlet 120. Thus, the shell 100 provides a guard against the contamination of the discharge outlet 120 through its dimensional structure.

In operation, when a user activates the valve to dispense the liquid from within the container, fluid is discharged through channel 134 of the discharge outlet 120 in a manner that substantially prevents the liquid from contacting the inner wall 104 of the shell 100. Thus, while the shell 100 may promote the efficient use of the drip resistant dispensing valve 12 by providing an indicator to the user of where to locate a receptacle to receive the liquid during dispensing, it is generally not directly involved with the dispensing of the liquid itself. This may promote an environment on the inner wall 104 of the shell 100 capable of remaining substantially free from contaminates and/or as previously mentioned, assist in avoiding the travel of contaminates onto or into the discharge outlet 120 and outlet channel 134.

The thickness of the walls provided for the shell 100 and discharge outlet 120 may vary to accommodate the needs of various liquids and/or materials to be dispensed through drip resistant valve 12 connected to a container of the liquids/materials, so long as the construction maintains sufficient integrity to undergo the above-described sterilization and irradiation processes. In a preferred embodiment, the outer shell 100 and discharge outlet 120 have wall thicknesses of approximately 0.06 inches. The thickness of the walls assists in promoting the ease of operation and cleaning of the drip resistant valve 12 and the ability of the valve to be subjected to sterilization processes while maintaining its functionality.

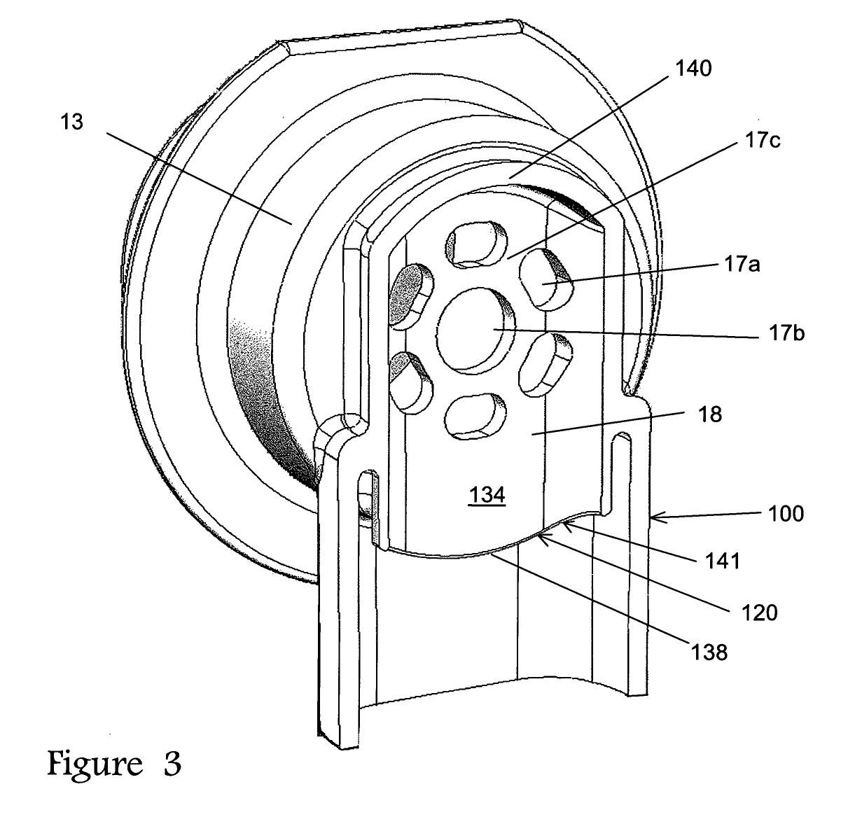

As shown more particularly in FIGS. 3 and 4, a valve port wall 17 extends across the interior of body 13 between inlet opening 15 and discharge outlet 120. The valve port wall 17 defines a set of holes or valve ports 17a, as well as a valve seat 18 encircling the valve ports 17a and facing toward the inlet opening 15. The valve port wall also defines a plunger guide opening 17b adjacent the central axis of the valve body 13. As best seen in FIG. 4, a plunger guide support wall 5 extends across the valve body 13 just outward of discharge outlet 120, so that the plunger guide support wall 5 lies between the discharge outlet channel 134 and the actuator end of the valve body. A tubular plunger guide 20 extends outwardly from the plunger guide support wall 5, toward the actuator end 9 of the valve body 13. The plunger guide 20 is aligned with the plunger guide opening 17b of the valve port wall 17. The valve body 13 may also have a pair of grip wings 30 and 31 projecting outwardly from the remainder of the valve body 13 at actuator end 9. Grip wings 30 and 31 extend generally in directions perpendicular to the axial direction of the valve body and parallel to the direction of discharge outlet 120. Valve body 13 desirably is formed from a polymeric material compatible with the fluid to be dispensed as, for example, a thermoplastic such as polypropylene or other polyolefin. In a preferred embodiment, valve body 13 is formed from a polypropylene copolymer.

A plunger member 21 is slidably mounted in plunger guide 20. Plunger member 21 desirably is also made of polypropylene or other plastic material. In a preferred embodiment, plunger member 21 is likewise formed from a polypropylene copolymer. Plunger member 21 has an inner end 22 that extends through the plunger guide support wall 5, through discharge outlet 120 and through the plunger guide opening 17b of valve port wall 17 into the inlet opening 15.

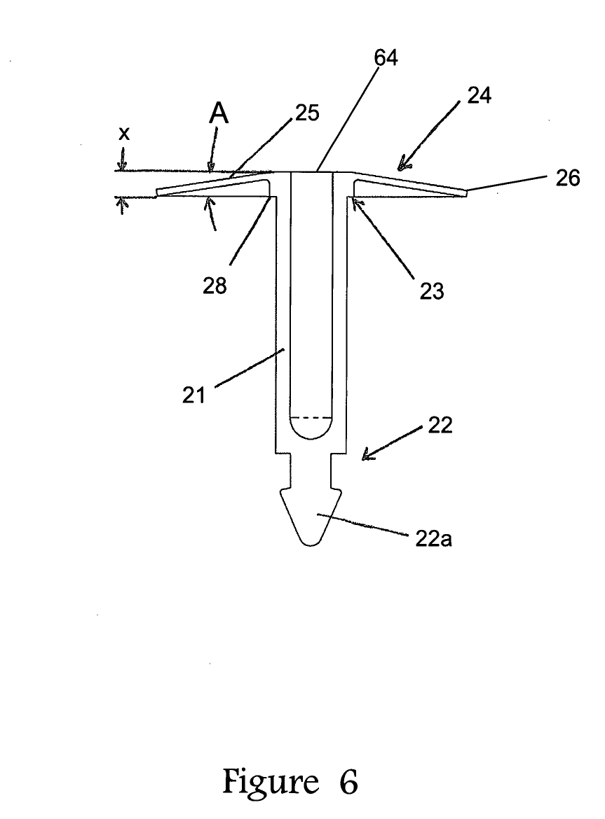

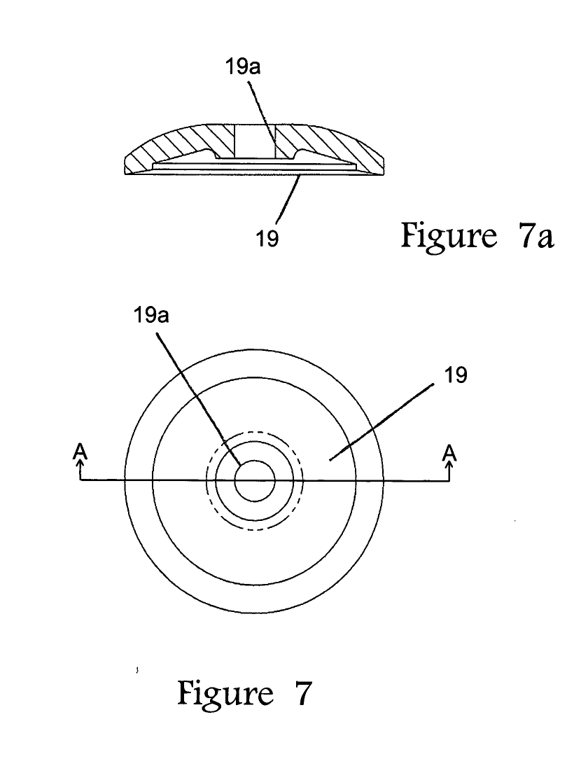

Referring to FIGS. 6, 7, and 7a, a resilient valve seal 19 in the form of a shallow conical member is fixedly connected to the inner end 22 of the plunger member, as by a coupling element 22a that can be force fitted into engagement with a sized opening 19a in the valve seal 19 because of the resilient nature of the materials from which the valve seal 19 and plunger 21 are fabricated. Valve seal 19 can be formed from essentially any resilient material that will not react with or contaminate the fluid being dispensed, and that will not melt or degrade under the conditions encountered in service. For example, a thermoplastic or thermosetting elastomer or other flexible material, typically in the range of about 30 to about 80 Shore A durometer, and more preferably, about 50 to about 80 Shore A durometer, can be employed in typical beverage dispensing applications. In a preferred embodiment, valve seal 19 is formed from a thermoplastic rubber. The periphery of valve seal 19 overlies valve seat 18 and seals against the valve seat when the valve is in the closed position depicted in FIG. 4.

The thickness of the valve seal will depend on the material and operating conditions. Merely by way of example, in a valve for dispensing beverages under gravity head (e.g., on the order of 0.5 to 1 pound per square inch pressure), the valve seal is about 1 inch in diameter and about 0.020 to 0.040 inches thick, most preferably about 0.032 inches thick, at its periphery.

A cylindrical stop member 28 and actuator 24 are formed integrally with the plunger member 21 at the outer end 23 of plunger member 21 remote from the inner end 22. Actuator 24 has a dome-shaped resilient section 25, so sized that the perimeter 26 of this dome-shaped section can be mounted or held from escaping by a ledge or groove 27 disposed on the inner wall 13b of the valve 13, just inward of the actuator end of the valve body 13. The dimensions of the actuator are selected to provide the desired resilient action and force/deflection characteristics as discussed below. In one exemplary embodiment, the plunger 21, stop member 28, and actuator 24, including resilient section 25, are molded as a unit from polycarbonate or similar material. The resilient section 25 is generally conical and about 1 inch in diameter, with an included angle of about 160°. That is, the wall of the conical resilient section lies at an angle A (FIG. 6) of 10° to the plane perpendicular to the axial direction of the plunger member. The resilient section 25 is about 0.012 inches thick at its perimeter, and about 0.018 inches thick at its juncture with stop member 28. Stop member 28 is about 0.292 inches in diameter. Thus, the ratio between the axial extent x of the conical resilient section and the average thickness of the resilient section is about 4:1.

Stop member 28 coacts with a stop shoulder 29 formed by the outer end of the plunger guide 20. Thus, the distance that the plunger 21 can be moved when force is exerted on the plunger 21 at actuator 24 will be determined by the distance the stop member 28 can travel before contact is made with the stop shoulder 29.

A positioning flange 14a is preferably provided circumscribing the valve body just above connecting features 14. When the drip resistant dispensing valve 12 is installed on a fluid container, positioning flange 14a abuts the exterior wall of the container. In its closed position (seated against the port wall), the valve seal is positioned a short axial distance from positioning flange 14a, preferably not more than about 0.25 inches, so as to limit the amount of fluid contained within the portion of the valve outside of the fluid container to the volume within the inlet end of the valve between positioning ring 14a and the valve seal. By limiting the amount of fluid that may be contained within the valve structure after a dispensing cycle, the risk of subjecting a dose of liquid held within the valve after a dispensing cycle to temperature fluctuations is reduced, in turn reducing the risk of dispensing a dose of spoiled liquid at the start of the following dispensing cycle.

In operation, the valve 12 is preferably mounted to a fluid container (not shown). The discharge opening preferably points downwardly outside of the container, whereas finger grip wings 30 and 31 project horizontally. The valve normally remains in the fully closed position depicted in FIG. 4. In this position, the resilience of actuator 24 urges the plunger 21 outwardly, toward the actuator end 9 of the housing, and holds the valve seal 19 in engagement with seat 18, so that the valve seal 19 blocks flow from the inlet opening 15 to ports 17a and discharge outlet 120. In this condition, the pressure of the liquid in the container tends to force the valve seal 19 against seat 18, thereby closing the valve tighter. Those portions 17c of the valve port wall 17 immediately surrounding the ports 17a support the valve seal and prevent it from buckling through into the outlet channel 134. This helps to assure that the seal will not be broken in the event very large fluid pressures are applied, as may occur, for example, if the container is shaken or dropped. The valve port wall 17 also provides an additional guide for plunger 21, that facilitates sliding movement of the plunger, reduces any tendency of the plunger to bind, and keeps seal 19 concentric with seat 18.

In the embodiment of the instant invention shown in FIG. 4, a separate push button element 60 is provided for manual engagement by a user to operate the drip resistant dispensing valve 12. Push button 60 is preferably formed as a disk having a generally planar top surface 61 and a bottom surface 62 on the opposite side from the top surface 61. Extending downward from and centrally located on bottom surface 62 is an engagement pin 63. In the embodiment of the instant invention depicted in FIG. 5, the dome-shaped resilient section 25 of actuator 24 is provided with a central opening 64 sized to receive engagement pin 63 therein and to hold the same in place via a friction fit. Thus, depressing push button element 60 downward and into tubular volume body 13 likewise causes plunger member 21 and valve seal 19 to move in an opening direction aligned with the central axis of the valve body and transverse to valve port wall 17. Preferably, engagement pin 63 is provided a circumferential ring 63a positioned around pin 63 adjacent to the point at which pin 63 attaches to bottom surface 62. Ring 63a defines a ledge 63b generally parallel to bottom surface 62. When inserted into actuator 24, pin 63 thus fits snugly within central opening 64 in actuator 24, while ledge 63b lies flush against the top face of actuator 24. Thus, when push button element 60 is pushed downward, only ledge 63b comes in contact with actuator 24, thus ensuring that the dome-shaped resilient section does not lose its shape or its spring characteristic when the button is actuated.

In an alternate embodiment of the instant invention, push button element 60 further comprises a detachable tamper indicating ring 70 circumscribing push button element 60. Tamper indicating ring 70 is defined by an outer vertical wall 71, a top wall 72, and an inner vertical wall 73. Outer vertical wall 71 has a thickness 71a such that the bottom of outer vertical wall 71 defines a flat surface sized to seat against the actuation end 9 of tubular valve body 13 surrounding actuator 24. Inner vertical wall 73 is provided with a plurality of tabs 74 extending towards the interior of tamper indicating ring 7, each tab 74 having a narrow terminal section 75 at its bottom end, which terminal sections 75 are attached to the upper and outer edge of push button element 60. Tabs 74 are preferably configured so as to position push button element 60 substantially below the plane defined by the uppermost extent of top wall 72, such that when push button element 60 is assembled with actuator 24 within the drip resistant dispensing valve 12, the outermost point of the actuation end 9 is top wall 72. Thus, by recessing push button 60 into the structure of drip resistant dispensing valve 12 and below top wall 72, inadvertent or accidental actuation of the valve (through bumping against a surface, etc.) may be averted.

In use, a new drip resistant dispensing valve 12 is provided on an unused container with push button element 60 installed in actuator 24 with tamper indicating ring 70 intact. Upon the first actuation of the valve through depression of push button 60, movement of tamper indicating ring 70 is blocked by the upper edge of valve body 13, such that movement of push button element 60 into valve body 13 results in tamper indicating ring 70 separating from push button element 60 and falling away from drip resistant dispensing valve 12. Thus, previous actuation of valve 12 may be readily apparent to a user based upon either the presence or absence of tamper indicating ring 70 from push button element 60.

The user can open the valve by grasping the finger grip wings 30 and 31 with his or her fingers and pressing his or her thumb against the center section of the button 61 so as to intentionally move actuator 24, plunger member 21, and valve seal 19 in an opening direction aligned with the central axis of the valve body and transverse to valve port wall 17. Such movement takes the plunger member and valve seal from the normally closed position towards an open position, in which stop member 28 on the plunger engages stop wall 29 on the plunger bore of the valve body. In this open position, the valve seal is remote from valve port wall 17 and remote from seat 18, so that the valve seal does not occlude ports 17a and hence fluid can flow from container 10 to outlet channel 134.

Because the finger gripping members 30 and 31 extend generally transverse to the discharge outlet 120, and extend generally horizontally during use of the valve, the user's fingers will be supported above the bottom end of the discharge outlet 120, out of the stream of fluid discharged from the opening. Thus, if a hot fluid is being dispensed, it will not harm the user.

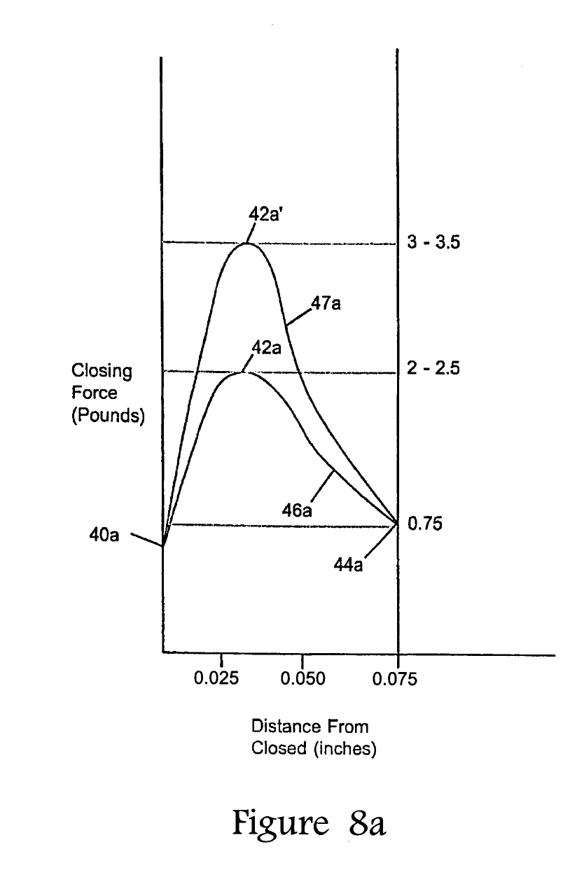

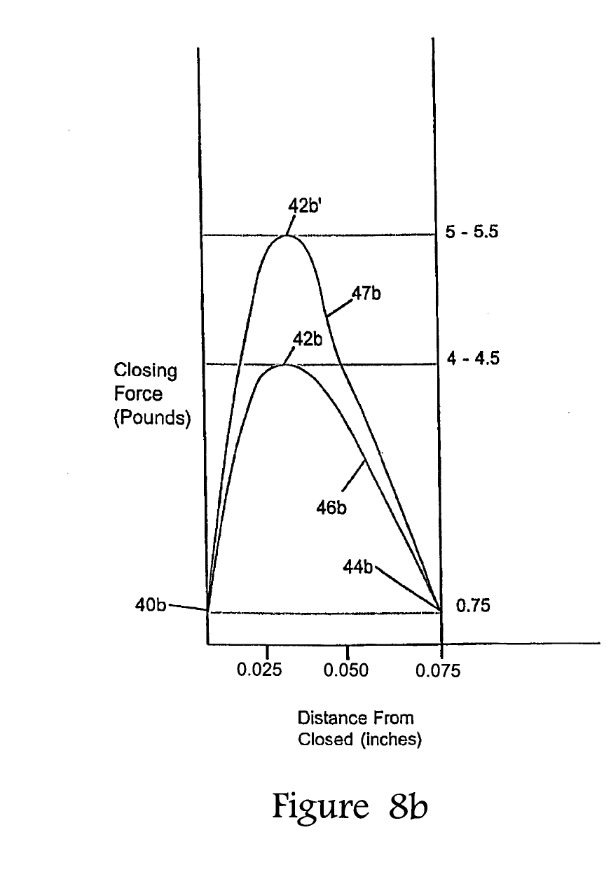

As the user forces the plunger 21 inwardly towards the open position, the resilient element 25 is deformed. The closing or outward force applied by the resilient element 25 may rise as the plunger is displaced. However, the closing force does not increase linearly with inward displacement toward the open position. As schematically shown in graphical form in FIG. 8a, the closing force curve 46a for the valve as described above first rises with opening displacement from the closed position 40a, but then the increase in closing force per unit opening displacement declines until the plunger member and valve seal reaches a point of maximum closing force at an intermediate position 42a, at which point the outward or closing force begins to decline with increasing opening displacement. The valve preferably exhibits a maximum closing force of 2 to 2.5 pounds at intermediate position 42a. The outward or closing force exerted by the resilient section 25 then decreases further with further opening displacement. However, the plunger 21 reaches the full open position 44a, where stop member 28 engages stop wall 29 (FIG. 5) and arrests opening displacement before the outward or closing force declines to zero. At such full open position 44a, the valve preferably requires a holding force of only 0.75 pounds. Stated another way, the dome-shaped or conical resilient section 25 provides a nonlinear spring characteristic with rising and falling force requirements to move the plunger 21. The travel distance set by stop member 28 and stop wall 29 is selected so that the full open position lies on the falling force section of the characteristic curve, with an opening force less than the maximum achieved during travel. In the exemplary embodiment discussed above, the total travel from full closed position to full open position is from about 0.025 inches to 0.075 inches.

In a first alternate embodiment depicted by force curve 47a, resilient element 25 is provided with a greater average thickness of approximately 0.02 inches, in turn requiring a larger closing force of approximately 3-3.5 pounds at intermediate position 42a′, and thereafter exhibiting a declining closing force until reaching a minimum of approximately 0.75 pounds to hold the valve in an open position. Such an increased intermediate closing force has been shown to provide a greater snap-type closure effect upon releasing the valve from the full open position, thus reducing the risk of inadvertent operation of the valve.

In a second alternate embodiment depicted by force curve 46b of FIG. 8b, resilient element 25 is formed from, for example, polyethylene terephthalate (PET) and dimensioned as discussed above with an average thickness of 0.015 inches. Such a construction for resilient element 25 requires an even larger closing force of approximately 4-4.5 pounds at intermediate position 42b, and thereafter exhibiting a declining closing force until once again reaching a minimum of approximately 0.75 pounds to hold the valve in an open position.

Still further, in yet a third alternate embodiment depicted by force curve 47b of FIG. 8b, resilient element 25 is again formed from PET and dimensioned with an average thickness of 0.02 inches, in turn requiring an even larger closing force of approximately 5-5.5 pounds at intermediate position 42b′, and thereafter exhibiting a declining closing force until once again reaching a minimum of approximately 0.75 pounds to hold the valve in an open position.

Thus, by using alternate polymers and thicknesses of actuator 24, the force versus displacement curve may be modified as shown in the various force curves of FIGS. 8a and 8b so that during inward displacement from full closed position 40 to full open position 44, intermediate positions 42 exhibit greater closing forces, thus increasing the snap-type closure effect upon release of the valve actuator.

Furthermore, by constructing each of the valve elements as discussed above, namely, forming the valve body from a polypropylene copolymer having a minimum average wall thickness of approximately 0.06 inches, and forming the valve seal from a thermoplastic rubber having an average thickness of about 0.03 inches, the valve structure may be subjected to the vigorous sterilization processes necessary for using the valve in food applications, including irradiating the structure at up to 5.0 MRAD and subjecting the structure to high temperature chemical and steam sterilization processes, without causing the valve structure to become brittle or otherwise jeopardizing the integrity of the valve's structure or operation.

The non-linear spring characteristic provides several significant advantages. It can provide a substantial closing force at the full closed position, and hence an effective seal, with a low holding force at the full open position. The user can keep the valve open while the liquid is flowing with only moderate effort. The highest actuating forces are encountered only briefly, during travel from the closed position to the open position, and do not tend to cause fatigue. By contrast, in a valve with a conventional linear spring, the highest closing forces are encountered at the full open position, so that the user must continually resist such high forces while the liquid is flowing. Further, the nonlinear spring action provides a desirable “feel” or tactile feedback, which confirms to the user that the valve is open even if the user cannot see the flow or is not looking at the flow.

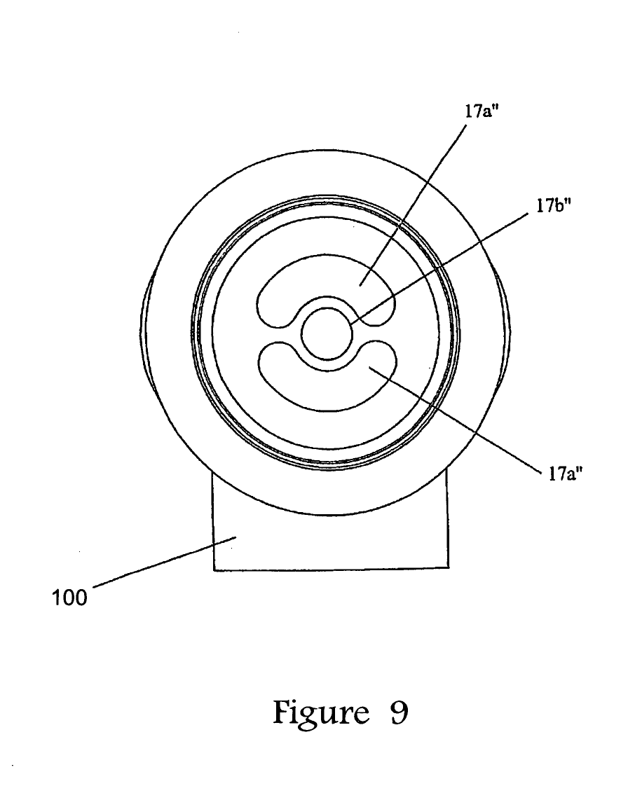

The fluid flow resistance of the valve 12 in the open position is controlled in large measure by the flow resistance of ports 17a. Thus, the fluid flow resistance of the valve can be selected to fit the application by selecting the number and size of the ports. The number and size of ports 17a can be varied through only slight modification of injection molding apparatus (such as by varying movable pin positions within such a mold structure). This allows the manufacturer to make valves for almost any application with minimal tooling costs. Ports 17a need not be round; other shapes, including arcuate ports 17a′ (FIG. 9) extending partially around the center of the valve body and partially around plunger guide opening 17b′, can be made with appropriate interchangeable injection molding components.

Since the drip resistant dispensing valve 12 as above described is made with only a few parts formed by conventional, simple molding techniques, it is relatively simple in operation and inexpensive to manufacture. It is inherently reliable, and does not require extreme precision in manufacture.

Those skilled in the art of spring design will readily recognize that the resilient element 25 may be disposed at the exposed or actuator end of the plunger, so that the resilient section acts as part of the push button and closes the actuator end of the housing. However, this is not essential, and the resilient element can be disposed within the valve body, at a location inaccessible to the user, as explained in detail above through use of push button element 60. In addition, although it is highly advantageous to form the resilient element integrally with the plunger member, this is not essential.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A dispensing valve for fluids comprising:
a valve body having an inlet and a dispensing outlet, said dispensing outlet further comprising a wall defining an open face at one end thereof, and attached to said valve body at an opposite end thereof, said open face having a radius of curvature about a longitudinal axis extending through said valve body; and
a shell having a wall defining an open face at one end thereof and attached to said valve body at an opposite end thereof, said shell extending around said dispensing outlet, and said open face of said shell being positioned a greater distance from said longitudinal axis than said open face of said dispensing outlet.

2. The dispensing valve of claim 1, further comprising
a valve port intermediate said inlet and said discharge outlet;
a resilient valve seal moveable from a closed position in which said valve seal occludes said valve port to an open position in which said valve seal does not occlude said valve port; and
a resilient actuator operatively connected to said resilient valve seal and operatively engaging said valve body so that said resilient actuator exerts a closing force on said resilient valve seal biasing said resilient valve seal towards said closed position, said resilient actuator exhibiting a nonlinear relationship between said closing force and displacement of said resilient valve seal from said closed position.

3. The dispensing valve of claim 2, wherein said resilient actuator is configured such that said nonlinear relationship causes said closing force to decrease upon displacement of said resilient valve seal to said open position from an intermediate position between said open position and said closed position.

4. The dispensing valve of claim 2, further comprising:
a plunger member reciprocally mounted within said valve body and having an outer end and an inner end, said outer end being attached to said resilient actuator, and said inner end being attached to said resilient valve seal.

5. The dispensing valve of claim 2, further comprising:
means for arresting opening movement of said plunger member and said resilient valve seal when said plunger member and said resilient valve seal reach said open position.

6. The dispensing valve of claim 2, further comprising:
a stop element on said plunger member and a stop element on said valve body, said stop elements engaging one another so as to arrest opening movement of said plunger member and said resilient valve seal when said plunger member and said resilient valve seal reach said open position.

7. The dispensing valve of claim 2, wherein said outer end of said plunger member is exposed for manual engagement by a user to open said dispensing valve, and said resilient actuator forms at least part of a push button for manual engagement by the user.

8. The dispensing valve of claim 7, wherein said valve body has an actuation end remote from said inlet and an actuator opening at said actuation end, said push button substantially occluding said actuator opening.

9. The dispensing valve of claim 2, further comprising:
a push button element exposed for manual engagement by a user to open said dispensing valve, said push button element being frictionally held by said resilient actuator.

10. The dispensing valve of claim 9, said push button element further comprising a generally planar disc having a top surface and a bottom surface, an engagement pin extending outward from said bottom surface, and a ring surrounding a portion of said engagement pin adjacent said bottom surface and defining a ledge generally parallel to said bottom surface.

11. The dispensing valve of claim 10, said pin being frictionally held within an opening in a top surface of said resilient actuator, and said ledge abutting said top surface of said resilient actuator adjacent said opening.

12. The dispensing valve of claim 9, said push button element further comprising a tamper indicating ring circumscribing said push button element and detachably affixed thereto.

13. The dispensing valve of claim 12, said tamper indicating ring comprising an outer vertical wall, a top wall, a bottom wall, and an inner vertical wall, and a plurality of tabs on said inner vertical wall having a weakened portion detachably holding said push button element.

14. The dispensing valve of claim 13, said plurality of tabs detachably holding a top surface of said push button in a vertical position below said top wall of said tamper indicating ring.

15. The dispensing valve of claim 2, wherein said valve body, said valve port wall, said resilient valve seal, and said resilient actuator are formed from materials selected for their ability to withstand gamma and cobalt irradiation exposure of at least 5.0 MRAD.

16. The dispensing valve of claim 1, wherein said shell and said discharge outlet are integrally connected with said body.

17. The dispensing valve of claim 1, wherein said open face of said discharge outlet forms a projecting surface having a minimum thickness.

18. The dispensing valve of claim 17, wherein said projecting surface extends outwards from a wall of said valve body a distance that is at least three times the thickness of said projection.

19. The dispensing valve of claim 1, wherein said discharge outlet forms a fluid discharge channel and said shell forms a channel at least partially surrounding said fluid discharge channel.

20. The dispensing valve of claim 19, wherein a sufficient distance is provided between an outer edge of said fluid discharge channel and an outer edge of said shell channel to prevent fluid transiting said valve from contacting said shell channel.

21. A dispensing valve for fluids comprising:
a valve body comprising:
(1) a first elongate channel having a rigid exterior wall defining a generally annular passage extending from a fluid inlet end to an actuator end;
(2) a fluid discharge outlet intermediate said inlet end and said actuator end, said dispensing outlet further comprising a wall defining an open face at one end thereof, and attached to said valve body at an opposite end thereof, said open face having a radius of curvature about a longitudinal axis extending through said valve body; and
(3) a shell at least partially surrounding said discharge outlet, said shell further comprising a wall defining an open face at one end thereof and attached to said valve body at an opposite end thereof, and said open face of said shell being positioned a greater distance from said longitudinal axis than said open face of said dispensing outlet;
a valve port wall intermediate said inlet end and said discharge outlet, said valve port wall defining a valve port;
a resilient valve seal moveable from a closed position in which said valve seal occludes said valve port to an open position in which said valve seal does not occlude said valve port; and
a resilient actuator operatively connected to said resilient valve seal and operatively engaging said valve body so that said resilient actuator exerts a closing force on said resilient valve seal biasing said resilient valve seal towards said closed position, said resilient actuator exhibiting a nonlinear relationship between said closing force and displacement of said resilient valve seal from said closed position.

22. The dispensing valve of claim 21, further comprising:
a plunger member reciprocally mounted within said valve body and having an outer end and an inner end, said outer end being attached to said resilient actuator, and said inner end being attached to said resilient valve seal.

23. The dispensing valve of claim 22, wherein said discharge outlet further comprises a second elongate channel having a rigid exterior wall defining a generally annular passage having an end terminating inside said valve body in fluid communication with said fluid inlet end and an open outlet end remote from said valve body, such second elongate channel extending from said valve port to said open outlet end.

24. The dispensing valve of claim 21, wherein said open face of said discharge outlet forms a projecting surface having a minimum thickness.

25. The dispensing valve of claim 24, wherein said projecting surface extends outwards from a wall of said valve body a distance that is at least three times the thickness of said projection.

26. The dispensing valve of claim 21, wherein said discharge outlet forms a fluid discharge channel and said shell forms a channel at least partially surrounding said fluid discharge channel.

27. The dispensing valve of claim 26, wherein a sufficient distance is provided between an outer edge of said fluid discharge channel and an outer edge of said shell channel to prevent fluid transiting said valve from contacting said shell channel.

28. The dispensing valve of claim 21, wherein said valve body, said valve port wall, said resilient valve seal, and said resilient actuator are formed from materials selected for their ability to withstand gamma and cobalt irradiation exposure of at least 5.0 MRAD.
